(19) United States
(12) Patent Application Publication
(10) Pub. No.: US 2017/0251860 A1
(43) Pub. Date: Sep. 7, 2017

(54) AUTOMATIC DRIP COFFEE MACHINE

(71) Applicant: BSEC ELECTRONICS CO., LTD., Incheon (KR)

(72) Inventor: Ja Sung KIM, Seoul (KR)

(73) Assignee: BSEC ELECTRONICS CO., LTD., Incheon (KR)

(21) Appl. No.: 15/433,095

(22) Filed: Feb. 15, 2017

(30) Foreign Application Priority Data
Feb. 15, 2016 (KR) 10-2016-0017000

(51) Int. Cl. A47J 31/057; A47J 31/46; A47J 31/44

(52) U.S. Cl. CPC A47J 31/057; A47J 31/4475; A47J 31/465; A47J 31/4403

(57) ABSTRACT

An automatic drip coffee machine includes a drip part, a hot water supply unit, a pedestal, a load cell, and a controlling part. The drip part pours water into a dripper containing coffee beans in a predetermined amount to brew coffee. The hot water supply unit provides the heated water to the drip part. The pedestal supports a drip container for supporting the dripper and storing the extracted coffee by the dripper. The load cell is disposed in the pedestal and measures weights of the dripper and the drip container. The controlling part calculates an error value between a predetermined water injection amount of the drip part and an amount of water actually poured from the drip part into the dripper using weights of the dripper and the drip container measured by the load cell and readjusts the water injection amount of the drip part based on the error value.

### CROSS-REFERENCE TO RELATED APPLICATION

This application claims the priority benefit of Korean Patent Application No. 10-2016-0017000, filed on Feb. 15, 2016, and all the benefits accruing therefrom under 35 U.S.C. §119, the contents of which are incorporated by reference in their entirety.

### TECHNICAL FIELD

Example embodiments disclosure relate to a coffee drip machine, and more particularly, to an automatic coffee drip machine capable of automatically dripping coffee in a hand drip manner(a pour-over manner).

### BACKGROUND

In general, a coffee brewing method includes an espresso coffee brewing method using a booster feed water pump and a drip coffee brewing method using a water stream falling by gravity.

The drip coffee brewing method includes a drip method using an electric coffee-maker and a hand drip method (a pour-over method) in which a user directly pours water onto ground coffee beans.

The drip method using an electric coffee-maker is a method of automatically brewing coffee by supplying ground coffee beans and water to the electric coffee-maker, and has the merits that the coffee brewing method is simple and brewed coffee can be kept warm for a long time. However, when a large amount of ground coffee beans are brewed and kept warm, the drip method using an electric coffee-maker remarkably reduces taste and flavor of coffee. And, the longer the electric coffee-maker keeps the brewed coffee, the more it has a burnt taste of the brewed coffee. Also, the drip method using an electric coffee-maker extracts pernicious ingredients contained ground coffee beans, because the electric coffee-maker brews coffee and water path through ground coffee beans for hours. Further, in the process of extracting coffee, the taste and flavor of coffee are deteriorated because coffee is extracted with a lot of impure taste.

The hand drip method is a manual coffee brewing method, in which a user puts ground coffee into a dripper, and then pours boiling water onto the ground coffee using a drip pot thereby extracting coffee. This method has the merits that the taste and flavor of coffee can be maximized better than the drip method using the electric coffee-maker because the user can adjust the method of pouring water according to properties of each coffee bean type and type of the dripper. However, because the hand drip method pours water by hand, the coffee brewing recipe is different for each person. Also, the amount, speed, and direction of pouring water onto the ground coffee are irregular, and it is difficult to supply water in a set amount for each of pouring turns. As a result, the taste of coffee may be changed every time it is brewed and different depending on who has brewed the coffee. As a prior art related to the present invention, Korean Patent No. 10-0897948 (issued on May 8, 2009) is disclosed.

### SUMMARY

The present disclosure provides an automatic drip coffee machine capable of automatically brewing coffee in the hand drip manner by pouring water in a set amount.

In accordance with an aspect of the present invention, an automatic drip coffee machine may include a drip part pouring water into a dripper containing ground coffee beans in a predetermined amount to brew coffee, a hot water supply unit heating water and providing the heated water to the drip part, a pedestal supporting a drip container for supporting the dripper and storing the extracted coffee by the dripper, a load cell disposed in the pedestal and measuring weights of the dripper and the drip container so as to measure an amount of water actually poured from the drip part into the dripper, and a controlling part adjusting a temperature of the water stored the hot water supply unit and setting a water injection amount of the drip part to be poured into the dripper. In particularly, the controlling part may calculate an error value between a predetermined water injection amount of the drip part and an amount of water actually poured from the drip part into the dripper using weights of the dripper and the drip container measured by the load cell and may readjust the water injection amount of the drip part based on the error value.

In accordance with some exemplary embodiments of the present disclosure, the automatic drip coffee machine may further include an input part for receiving a menu setting command for brewing coffee by an operation of a user. In particularly, the controlling part may set an amount of extracting coffee, a coffee bloom time after wetting, a number of pours, an interval between pours, and a water injection amount per a pour of the drip part based on the menu setting command inputted through the input part by the user.

In accordance with some exemplary embodiments of the present disclosure, the drip part may include a drip nozzle disposed above the pedestal and spraying water provided from the hot water supply unit into the dripper, a hot water supply line connected the hot water supply unit and the drip nozzle to provide the water from the hot water supply unit to the drip nozzle, and a metering pump regulating an amount and pressure of water provided from the hot water supply unit to the drip nozzle.

In accordance with some exemplary embodiments of the present disclosure, the controlling part may control the metering pump so as to adjust the water injection amount of the drip part and a water injection pressure of the drip part.

In accordance with some exemplary embodiments of the present disclosure, the controlling part may control the metering pump according to the user's menu setting command so as to adjust a water injection pressure of the drip part for each pouring turn.

In accordance with some exemplary embodiments of the present disclosure, the drip nozzle may include a plurality of injection holes for spraying water. Further, the drip nozzle may spray the water in a shower spraying manner so as to uniformity spray the water onto the ground coffee beans contained in the dripper.

In accordance with some exemplary embodiments of the present disclosure, the hot water supply unit may include a hot water tank storing water and heating the stored water to a predetermined temperature, and a temperature sensor sensing a temperature of water stored in the hot water tank so as to transmit the sensed temperature to the controlling part. In particularly, the controlling part may adjust the temperature of water stored in the hot water tank based on the sensed temperature received from the temperature sensor.

According to the example embodiments of the present invention, the automatic drip coffee machine may readjust the water injection amount of the drip part by comparing the amount of water actually injected from the drip part into the dripper with the predetermined water injection amount of the drip part. Accordingly, the water injection amount error of the drip part due to the driving error of the metering pump may be reduced, and a set amount of water may be accurately poured into the ground coffee beans contained in the dripper. As a result, the automatic drip coffee machine may improve and maintain the flavor and taste of the coffee.

Also, the automatic drip coffee machine may set the coffee bloom time, the number of pours, the interval between pours, and so on by the user' operation. Accordingly, the automatic drip coffee machine may brew coffee that suits user's taste rather than uniformly having the same taste and flavor, and may brew coffee in a manner suited to each kind of coffee bean varieties and the type of the dripper. As a result, the automatic drip coffee machine may improve the quality of service.

### BRIEF DESCRIPTION OF THE DRAWINGS

Exemplary embodiments can be understood in more detail from the following description taken in conjunction with the accompanying drawings, in which:

FIG. 1 is a perspective view illustrating an automatic drip coffee machine in accordance with an exemplary embodiment of the present invention;

FIG. 2 is an internal schematic view illustrating the automatic drip coffee machine in FIG. 1;

FIG. 3 is a schematic view illustrating the operation relationship between the internal components of the automatic drip coffee machine in FIG. 2; and

FIG. 4 is a plan view illustrating a drip nozzle in FIG. 3.

### DETAILED DESCRIPTION OF EMBODIMENTS

Hereinafter, embodiments of the present invention are described in more detail with reference to the accompanying drawings. However, the present invention is not limited to the embodiments described below and is implemented in various other forms. Embodiments below are not provided to fully complete the present invention but rather are provided to fully convey the range of the present invention to those skilled in the art.

In the specification, when one component is referred to as being on or connected to another component or layer, it can be directly on or connected to the other component or layer, or an intervening component or layer may also be present. Unlike this, it will be understood that when one component is referred to as directly being on or directly connected to another component or layer, it means that no intervening component is present. Also, though terms like a first, a second, and a third are used to describe various regions and layers in various embodiments of the present invention, the regions and the layers are not limited to these terms.

Terminologies used below are used to merely describe specific embodiments, but do not limit the present invention. Additionally, unless otherwise defined here, all the terms including technical or scientific terms, may have the same meaning that is generally understood by those skilled in the art.

Embodiments of the present invention are described with reference to schematic drawings of ideal embodiments. Accordingly, changes in manufacturing methods and/or allowable errors may be expected from the forms of the drawings. Accordingly, embodiments of the present invention are not described being limited to the specific forms or areas in the drawings, and include the deviations of the forms. The areas may be entirely schematic, and their forms may not describe or depict accurate forms or structures in any given area, and are not intended to limit the scope of the present invention.

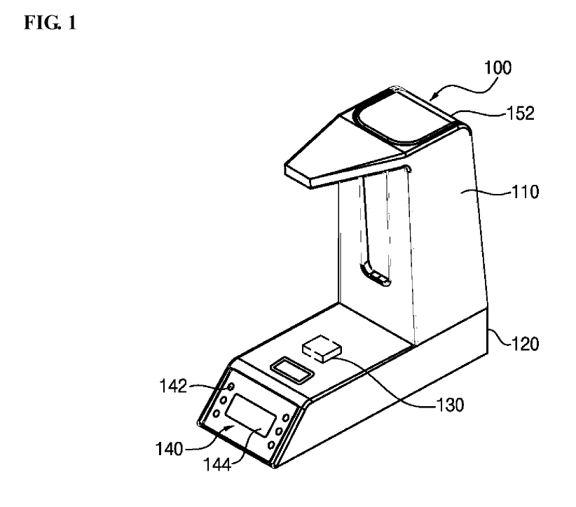

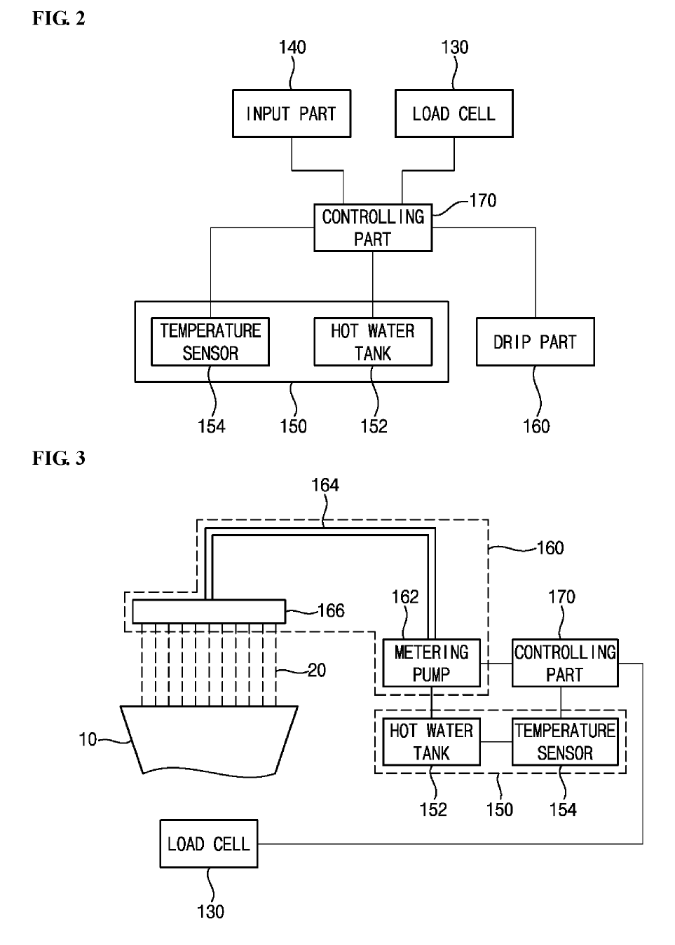

FIG. 1 is a perspective view illustrating an automatic drip coffee machine in accordance with an exemplary embodiment of the present invention, and FIG. 2 is an internal schematic view illustrating the automatic drip coffee machine in FIG. 1.

Referring to FIGS. 1 and 2, in accordance with and exemplary embodiment of the present disclosure, an automatic drip coffee machine 100 is capable of automatically brewing coffee in a hand drip manner (a pour-over manner), and may include a housing 110 and a pedestal 120 disposed under the housing 110.

A drip container such as a drip server for storing extracted coffee by the automatic drip coffee machine 100 may be placed on the pedestal 120, and a dripper containing ground coffee beans for coffee brewing may be placed on the drip server.

A load cell 130 may be disposed in the pedestal 120. The load cell 130 may measure weights of the dripper and the drip server in order to measure an amount of water actually poured from the automatic drip coffee machine 100 into the dripper.

An input part 140 may be disposed on a front surface of the pedestal 120 to receive a command by a user's operation. As shown in FIG. 1, the input part 140 may include a menu button 142 for the user to input the command, and a display part 144 for displaying a current state of the automatic drip coffee machine 100, an input menu and so on.

In an example embodiment, the input part 140 is disposed on the front surface of the pedestal 120 but may be disposed on one side of the housing 110.

Meanwhile, a hot water supply unit 150 for heating and storing water, a drip part 160 for pouring water in a set amount into the dripper, and a controlling part 170 may be disposed in the housing 110.

The hot water supply unit 150 may store water and heat the stored water to a predetermined temperature. Also, the hot water supply unit 150 may be supply the heated water to the drip part 160. The drip part 160 may pour the heated water into the dripper in a predetermined amount to brew coffee. The hot water supply unit 150 and the drip part 160 are controlled by the controlling part 170. The controlling part 170 may control the hot water supply unit 150 and the drip part 160 according to the command input through the input part 140.

Hereinafter, components of the hot water supply unit 150 and the drip part 160, and operation of the hot water supply unit 150, the drip part 160 and the controlling part 170 will be explained in detail with reference to the accompanying drawings.

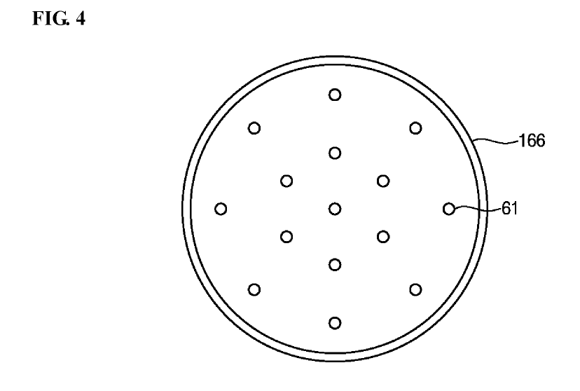

FIG. 3 is a schematic view illustrating the operation relationship between the internal components of the automatic drip coffee machine as shown in FIG. 2, and FIG. 4 is a plan view illustrating a drip nozzle as shown in FIG. 3.

Referring to FIGS. 2 to 4, the hot supply unit 150 may include a hot water tank 152 and a temperature sensor 154. The hot water tank 152 may store water and heat the stored water to the predetermined temperature. The temperature sensor 154 may sense a temperature of water stored in the hot water tank 152, and transmit the sensed temperature to the controlling part 170. The controlling part 170 may adjust the temperature of the water stored in the hot water tank 152 according to the sensed temperature received from the temperature sensor 154. Although not shown in figures, the hot water tank 152 may include a heater to heat the stored water.

The water stored in the hot water tank 152 may be provided to the drip part 160 to brew coffee. The drip part 160 may include a metering pump 162, a hot water supply line 164, and a drip nozzle 166.

In detail, the water stored in the hot water tank 152 is provided to the drip nozzle 166 through the hot water supply line164. The drip nozzle 166 pours the provided water onto ground coffee beans contained in the dripper 10. At this time, the metering pump 162 may regulate the amount and pressure of water provided from the hot water tank 152 to the hot water supply line 164 under the control of the control part 170, as a result, the drip nozzle 166 may pour water onto the ground coffee beans in a predetermined amount at a predetermined pressure.

The drip nozzle 166 may be disposed above the pedestal 120 (see FIG. 1), and may have a plurality of injection holes 61 for spraying water as shown in FIG. 4.

In an example embodiment, as shown in FIG. 3, the drip nozzle 166 may spray water in a shower spraying manner so as to uniformly spray the water onto the ground coffee beans contained in the dripper 10.

The controlling part 170 may set an amount of extracting coffee, a coffee bloom time after wetting, a number of pours, an interval between pours, and a water injection amount per a pour of the drip part 160 based on a menu setting command. The menu setting command is input through the input part 140 by the user' operation. The controlling part 170 may control the metering pump 162 according to the water injection amount per a pour per set by the user's operation. Thereby, the drip part 160 may pour the water 20 into the dripper 10 in a predetermined amount set by the user. Here, the controlling part 170 may adjust a water injection pressure of the drip part 160 differently each pouring turn. For example, a water injection pressure at the first pour after the coffee bloom and a water injection pressure at the second pour may be set to be different from each other.

In particular, the controlling part 170 may calculate an error between a predetermined water injection amount of the drip part 160 and an amount of water actually poured from the drip part 160 into the dripper 10 using the weights of the dripper 10 and the drip container measured by the load cell 130, and may readjust the water injection amount of the drip part 160 based on the calculated error value. In other words, the controlling part 170 calculates the amount of water actually injected from the drip part 160 into the dripper 10 based on the weights of the dripper 10 and the drip container measured by the load cell 130, and calculates the error between the currently set water injection amount of the drip part 160 and the measured water injection amount. The controlling part 160 controls the metering pump 162 based on the calculated error value to readjust the water injection amount of the drip part 160.

As described above, the automatic drip coffee machine 100 may readjust the water injection amount of the drip part 160 by comparing the amount of water actually injected from the drip part 160 into the dripper 10 with the predetermined water injection amount of the drip part 160. Accordingly, the water injection amount error of the drip part 160 due to the driving error of the metering pump 162 may be reduced, and a set amount of water may be accurately poured into the ground coffee beans contained in the dripper 10. As a result, the automatic drip coffee machine 100 may improve and maintain the flavor and taste of the coffee.

Further, the automatic drip coffee machine 100 may set the coffee bloom time, the number of pours, the interval between pours, and so on by the user' operation. Accordingly, the automatic drip coffee machine 100 may brew coffee that suits user's taste rather than uniformly having the same taste and flavor, and may brew coffee in a manner suited to each kind of coffee bean varieties and the type of the dripper 10. As a result, the automatic drip coffee machine 100 may improve the quality of service.

Although the automatic drip coffee machine has been described with reference to specific embodiments, they are not limited thereto. Therefore, it will be readily understood by those skilled in the art that various modifications and changes can be made thereto without departing from the spirit and scope of the present disclosure defined by the appended claims.

What is claimed is:

1. An automatic drip coffee machine comprising:
a drip part pouring water into a dripper containing ground coffee beans in a predetermined amount to brew coffee;
a hot water supply unit heating water and providing heated water to the drip part;
a pedestal supporting a drip container for supporting the dripper and storing coffee extracted from the dripper;
a load cell disposed in the pedestal, and measuring weights of the dripper and the drip container so as to measure an amount of water actually poured from the drip part into the dripper; and
a controlling part adjusting a temperature of the water stored in the hot water supply unit and setting a water injection amount of the drip part to be poured into the dripper, wherein the controlling part calculates an error value between a predetermined water injection amount of the drip part and an amount of water actually poured from the drip part into the dripper obtained using values of weights of the dripper and the drip container measured by the load cell and readjusts the water injection amount of the drip part based on the error value.

2. The automatic drip coffee machine of claim 1, further comprising an input part for receiving a menu setting command for brewing coffee by an operation of a user,
wherein the controlling part sets an amount of extracting coffee, a coffee bloom time after wetting, a number of pours, an interval between pours, and a water injection amount per a pour of the drip part based on the menu setting command inputted through the input part by the user.

3. The automatic drip coffee machine of claim 1, wherein the drip part comprises a drip nozzle disposed above the pedestal and spraying water provided from the hot water supply unit into the dripper, a hot water supply line connected the hot water supply unit and the drip nozzle to provide the water from the hot water supply unit to the drip nozzle, and a metering pump regulating an amount and pressure of water provided from the hot water supply unit to the drip nozzle.

4. The automatic drip coffee machine of claim 3, wherein the controlling part controls the metering pump so as to adjust the water injection amount of the drip part and a water injection pressure of the drip part.

5. The automatic drip coffee machine of claim 3, wherein the controlling part controls the metering pump according to the user's menu setting command so as to adjust a water injection pressure of the drip part for each pouring turn.

6. The automatic drip coffee machine of claim 3, wherein the drip nozzle comprises a plurality of injection holes for spraying water and sprays the water in a shower spraying manner so as to uniformity spray the water onto the ground coffee beans contained in the dripper.

7. The automatic drip coffee machine of claim 1, wherein the hot water supply unit includes a hot water tank storing water and heating the stored water to a predetermined temperature, and a temperature sensor sensing a temperature of water stored in the hot water tank so as to transmit the sensed temperature to the controlling part.

8. The automatic drip coffee machine of claim 7, wherein the controlling part adjusts the temperature of water stored in the hot water tank based on the sensed temperature received from the temperature sensor.
